(19) United States
(12) Patent Application Publication
(10) Pub. No.: US 2023/0224180 A1
(43) Pub. Date: Jul. 13, 2023

(54) Recording Method and Recording Apparatus

(71) Applicant: Yamaha Corporation, Hamamatsu-shi (JP)

(72) Inventor: Naohiro EMOTO, Hamamatsu-shi (JP)

(21) Appl. No.: 18/095,269

(22) Filed: Jan. 10, 2023

(30) Foreign Application Priority Data
Jan. 11, 2022 (JP) 2022-002425

(51) Int. Cl. H04L 12/18; H04N 7/14

(52) U.S. Cl. CPC H04L 12/1831; H04N 7/147

(57) ABSTRACT

A recording apparatus receives image data and time information that are obtained by capturing a conference from a start time of the conference, sets a specific object from the image data as a target image, detects an event during the conference, and records detection timing of the event, time information in a past before the detection timing, and the image data in association with the time information.

### CROSS REFERENCE TO RELATED APPLICATIONS

This Nonprovisional application claims priority under 35 U.S.C. § 119(a) on Patent Application No. 2022-002425 filed in Japan on Jan. 11, 2022, the entire contents of which are hereby incorporated by reference.

### BACKGROUND

### Technical Field

An embodiment of the present disclosure relates to a method and apparatus of recording image data.

### Background Information

Japanese Patent No. 5140270 discloses a belongings monitoring system in which an image of belongings to which a wireless tag is attached is captured. The belongings monitoring system of Japanese Patent No. 5140270, when detecting specific belongings (a lost article), displays loss notification information.

Japanese Patent No. 4606379 discloses a remote control system in which a wireless IC tag is attached to a remote controller. The remote control system of Japanese Patent No. 4606379 emits an alarm tone when a situation in which the wireless IC tag is not able to be detected occurs.

Each system of Japanese Patent No. 5140270 and Japanese Patent No. 4606379 needs to previously register a target object to which a wireless tag is attached.

### SUMMARY

In view of the foregoing, an aspect of the present disclosure is directed to provide a recording method capable of managing a target object in connection with a conference without previously registering the target object.

A recording method according to an embodiment of the present disclosure receives image data and time information that are obtained by capturing a conference from a start time of the conference, sets a specific object from the image data as a target image, detects an event during the conference, and records detection timing of the event, time information in a past before the detection timing, and the image data in association with the time information.

According to an embodiment of the present disclosure, a target object in connection with a conference is able to be managed without previous registration.

### BRIEF DESCRIPTION OF THE DRAWINGS

FIG. 1 is a block diagram showing a configuration of a conference system 1 and a terminal 15.

FIG. 2 is a block diagram showing a configuration of a PC 11.

FIG. 3 is a block diagram showing a functional configuration of a recording apparatus.

FIG. 4 is a flow chart showing an operation of a recording method.

FIG. 5 is a block diagram showing a functional configuration of a recording apparatus (a PC 11A) according to a first modification.

FIG. 6 is a block diagram showing a functional configuration of a recording apparatus (a PC 11B) according to a second modification.

FIG. 7 is a view showing an example in which image data is recorded as conference minutes.

FIG. 8 is a view showing an example of conference minutes in a case in which a type of a specific object is identified.

FIG. 9 is a view showing conference minutes when time information and image data are recorded, in a case in which a sound changes.

FIG. 10 is a view showing conference minutes in a case in which talker recognition is performed and time information and image data are recorded for each talker.

### DETAILED DESCRIPTION

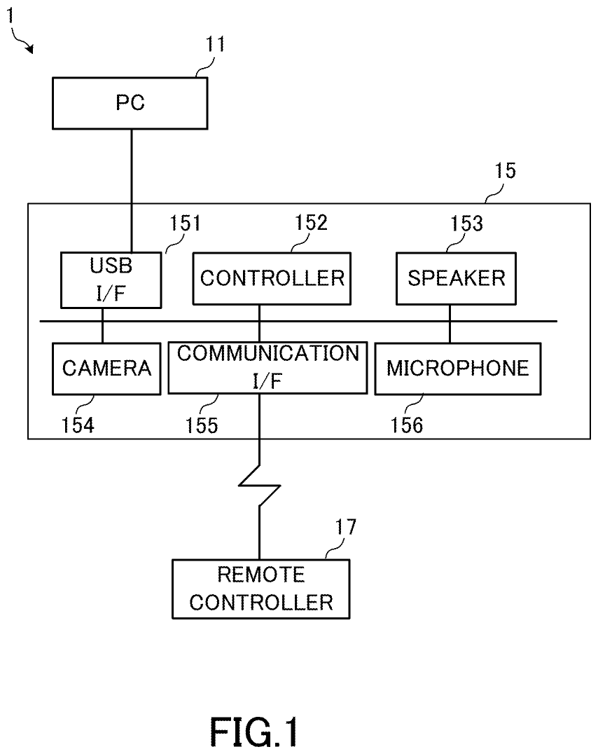

FIG. 1 is a block diagram showing a configuration of a conference system 1 and a configuration of a terminal 15. The conference system 1 includes a PC 11, a terminal 15, and a remote controller 17. The conference system 1 is a system for holding a Web conference by connecting to an information processing apparatus such as a PC at a remote place.

The terminal 15 includes a USB I/F 151, a controller 152, a speaker 153, a camera 154, a communication I/F 155, and a microphone 156. The terminal 15 is connected to the PC 11 through the USB I/F 151. The terminal 15 is connected to the remote controller 17 through the communication I/F 155. The terminal 15 and the remote controller 17 are connected by wire or wireless. The terminal 15 and the remote controller 17, when being connected by wireless, are connected to each other, for example, by a standard such as infrared rays or Bluetooth (registered trademark).

The controller 152 is configured by a microcomputer, for example, and collectively controls an operation of the terminal 15. The terminal 15 obtains a voice of a user of the conference system 1 through the microphone 156. The terminal 15 sends an audio signal according to an obtained voice to the PC 11, through the USB I/F 151. The terminal 15 obtains an image through the camera 154. The terminal 15 sends the image data according to an obtained image to PC 11, through the USB I/F 151. In addition, the terminal 15 receives the audio signal from the PC 11 through the USB I/F 151, and emits a sound through the speaker 153.

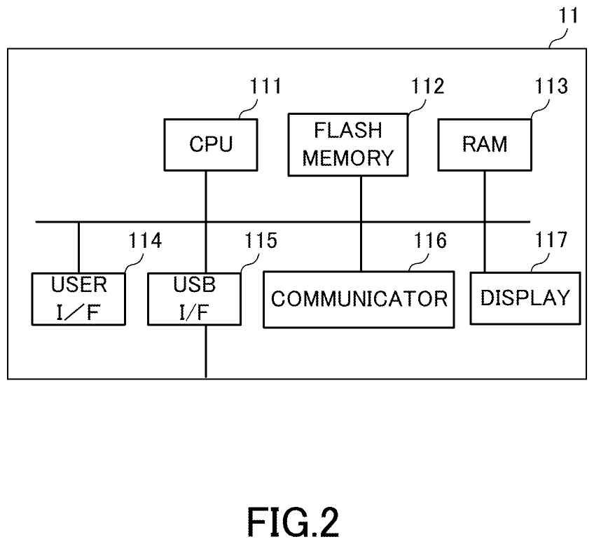

The PC 11 is a general personal computer. FIG. 2 is a block diagram showing a configuration of the PC 11. The PC 11 includes a CPU 111, a flash memory 112, a RAM 113, a user I/F 114, a USB I/F 115, a communicator 116, and a display 117.

The CPU 111, by reading a program for a Web conference from the flash memory 112 to the RAM 113, connects to a PC or the like at a remote place and holds a Web conference. The user I/F 114 includes a mouse and a keyboard, and receives an operation of a user. The user instructs to start the program for a Web conference, for example, through the user I/F 114.

In addition, the CPU 111 reads and executes the program for executing the recording method of the present disclosure, from the flash memory 112. The program according to the present embodiment is mounted as one function of an application program for operating the terminal 15 by the PC 11, for example. It is to be noted that the recording method according to the present embodiment may be mounted as one function in the program for a Web conference.

The USB I/F 115 is connected to the terminal 15. The PC 11 receives audio data and image data from the terminal 15 through the USB I/F 115. The PC 11 sends received audio data and image data to the PC or the like at a remote place, through the communicator 116. The communicator 116 is a network interface of a wireless LAN or a wired LAN, and is connected to the PC at a remote place. The PC 11 receives audio data and image data from the PC or the like at a remote place, through the communicator 116. The PC 11 sends received audio data to the terminal 15 through the USB I/F 115. In addition, the PC 11 displays a video according to a Web conference on the display 117, based on the image data received from the PC or the like at a remote place and the image data received from the terminal 15. It is to be noted that connection between the PC 11 and the terminal 15 is not limited to connection through the USB. The PC 11 and the terminal 15 may be connected by another communication means such as an HDMI (registered trademark), a LAN, or Bluetooth (registered trademark).

The remote controller 17 has a plurality of physical operators. The remote controller 17 receives an operation of a user through a physical operator. The remote controller 17 sends an operation signal according to a received operation, to the terminal 15. The user operates the remote controller 17 and operates the terminal 15. The user changes a capture direction, a capture range, or the like of the camera 154, for example. The user changes the volume of the speaker 153.

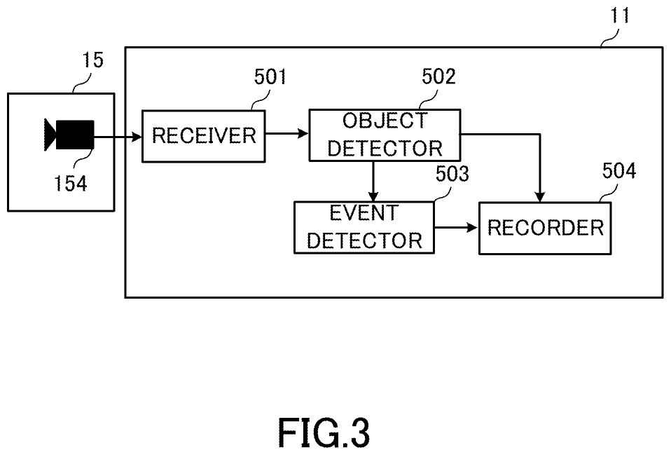

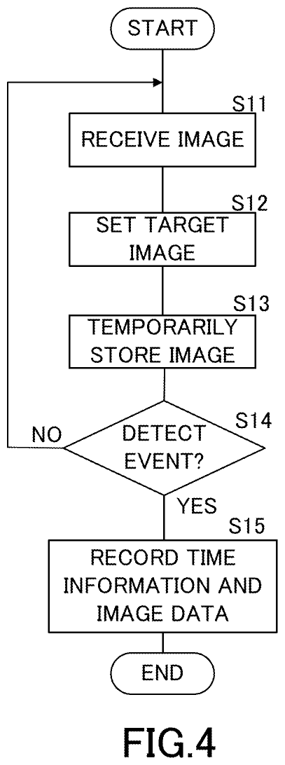

FIG. 3 is a block diagram showing a functional configuration of a recording apparatus achieved by the PC 11. FIG. 4 is a flow chart showing an operation of the recording method.

The PC 11 functionally includes a receiver 501, an object detector 502, an event detector 503, and a recorder 504. The receiver 501 receives image data from the camera 154 (S11). The object detector 502 detects a specific object from the obtained image data, and sets the specific object as a target image (S12).

In this example, the specific object is the remote controller 17. The object detector 502 recognizes a remote controller by using a predetermined algorithm using a neural network or the like, for example. The object detector 502 sets the remote controller as a target image.

The recorder 504 temporarily stores the image data including the target image that has been set by the object detector 502 (S13). The recorder 504 may temporarily store the image data in the flash memory 112 or may temporarily store the image data in the RAM 113. Alternatively, the recorder 504 may send the image data to a different apparatus such as a server, and may temporarily store the image data in the different apparatus such as the server.

The event detector 503 determines whether an event during a conference is detected (S14). In this example, the event detector 503 detects a change in the image of the remote controller 17 that has been set as a target image, as an example of the event during a conference. For example, the event detector 503 detects a fact that the object detector 502 has not been able to recognize the remote controller 17, as the event during a conference. The PC 11, in a case of detecting no event by the event detector 503 (S14: NO), returns to the processing of S11 and receives the image data of the following frame. As a result, temporary storage processing of the image data is repeated, and the image data received from the start of a conference to the present is sequentially accumulated in the flash memory 112 or the like.

The recorder 504, when detecting an event by the event detector 503 (S14: YES), records time information and image data (S15). The recorder 504 records at least detection timing of the event and time information in the past before the detection timing, and records the image data in association with the time information. The recorder 504 may record the time information and the image data in the flash memory 112, or may record the time information and the image data in another apparatus such as a server.

The recorder 504, from temporarily stored image data, records the detection timing of the event and image data in the past before the detection timing, in the flash memory 112 or the like. At this time, the recorder 504 deletes the temporarily stored image data.

The recorder 504 may record all time information and image data in the past before the detection timing, or may record time information and image data in the past only by a predetermined time (1 minute, for example) before the detection timing. In such a case, the recorder 504 is able to reduce a storage capacity by recording time information and image data in the past only by a predetermined time. As a matter of course, the recorder 504 may further record time information and image data after the detection timing.

The time information is clock time (absolute time) information, for example. The time information may be elapsed time (relative time) or the like from startup timing of the application program according to the present embodiment, startup timing of the program for a Web conference, or conference start timing (timing when connection to an information processing apparatus at a remote place is established).

As a result, the recorder 504 records image data corresponding to timing when the remote controller 17 can no longer be recognized, and image data in the past before the timing when the remote controller 17 can no longer be recognized. For example, in a case in which a user (a first user) of the conference system 1 has taken the remote controller 17 out of a conference room, the object detector 502 is not able to recognize the remote controller 17. Another user (a second user) of the conference system 1, in a case of noticing that the remote controller 17 has been lost, can easily determine at which time the remote controller 17 is lost, by referring to recorded time information. In addition, the second user, by referring to recorded image data, can easily determine that the first user has taken the remote controller 17. Alternatively, for example, even in a case in which the remote controller 17 has fallen under a desk or the like while the first user uses the conference system 1, the object detector 502 is not able to recognize the remote controller 17. The second user, in a case of noticing that the remote controller 17 has been lost, can easily determine that the remote controller 17 has fallen under a desk, by referring to the recorded image data.

In such a manner, the recording method according to the present embodiment is able to easily manage a target object (the remote controller 17 in this example) in connection with a conference, without previous registration by use of an IC tag or the like.

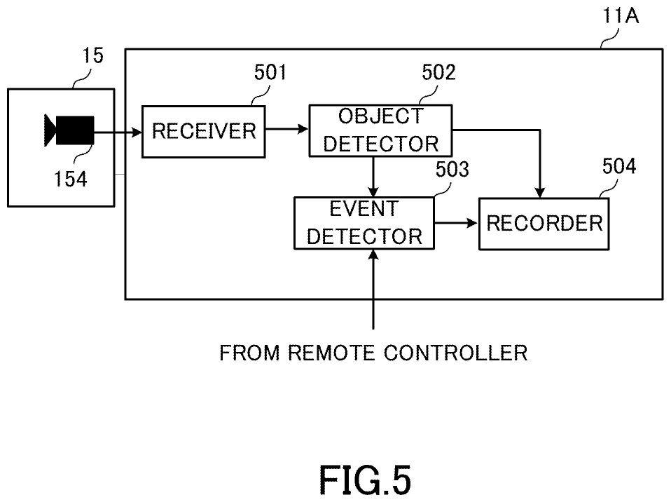

Next, FIG. 5 is a block diagram showing a functional configuration of a recording apparatus (a PC 11A) according to a first modification. The event detector 503 detects an operation to the remote controller 17 as an example of an event during a conference. In this example, the terminal 15, in a case of receiving an operation from the remote controller 17, notifies the PC 11A that a remote control operation has been received. The event detector 503, in a case of receiving such a notification, determines that an event has been detected.

As a result, the PC 11A, whenever receiving an operation from the remote controller 17, records time information and image data. Therefore, the user of the conference system 1, in a case of noticing that the remote controller 17 has been lost, can easily determine who has last operated the remote controller 17, by referring to the recorded time information and image data.

It is to be noted that, in a case in which the terminal 15 and the remote controller 17 are connected by the communication standards such as Bluetooth (registered trademark), the terminal 15, when connection to the remote controller 17 is released or when no beacon signal of Bluetooth (registered trademark) is detected, may notify the PC 11A. The event detector 503, in the case of receiving such a notification, determines that the event has been detected.

For example, in the case in which the first user of the conference system 1 has taken the remote controller 17 out of a conference room, no beacon signal is detected, so that the event detector 503 detects an event. In such a case as well, the second user of the conference system 1, in the case of noticing that the remote controller 17 has been lost, can easily determine at which time the remote controller 17 is lost, by referring to recorded time information. In addition, the second user, by referring to recorded image data, can easily determine that the first user has taken the remote controller 17.

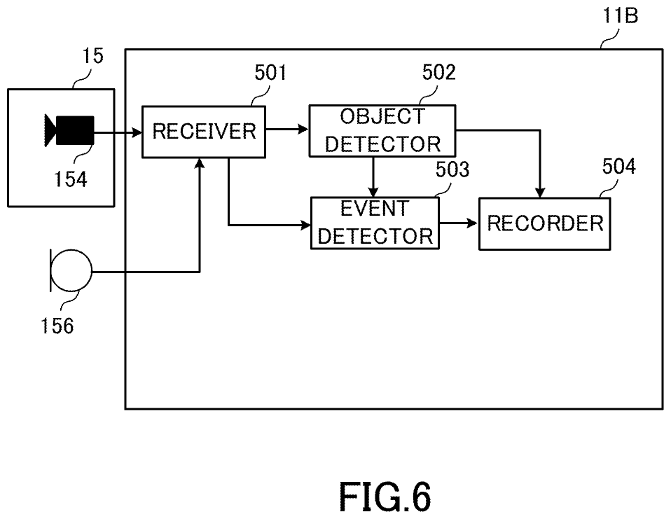

FIG. 6 is a block diagram showing a functional configuration of a recording apparatus (a PC 11B) according to a second modification. The receiver 501 of the PC 11B receives audio data from the microphone 156. The event detector 503 receives the audio data through the receiver 501. The event detector 503 detects a change in the audio data as an example of an event during a conference.

The event detector 503, in a case of detecting an occurrence of a sudden sound such as a door opening and closing sound or a chair movement sound, for example, determines that an event is detected. Alternatively, the event detector 503, in a case of detecting that the voice of a talker is changed from being voiced to being unvoiced or is changed from being unvoiced to being voiced, may determine that an event is detected.

The recorder 504 records time information and image data when a sound changes.

Accordingly, the PC 11B records time information and image data when a sound changes. For example, the PC 11B records time information and image data at such timing when a user enters a conference room, when the user leaves the conference room, when a conference starts, or when the conference ends. Therefore, the user, in the case of noticing that the remote controller 17 has been lost, can easily determine at which time the remote controller 17 is lost, who has last operated the remote controller 17, or the like, by referring to the recorded time information and image data. In addition, the user can also check the history of a person who has entered or left the conference room.

It is to be noted that the recorder 504, in a case of detecting an event by the event detector 503, may further record audio data in association with the time information and the image data. As a result, the user, in a case of various events such as a loss of the remote controller 17 and the like, can also check a sound in addition to the recorded time information and image data.

Moreover, the object detector 502 may receive the audio data through the receiver 501. The object detector 502 may perform talker recognition processing based on the audio data. The event detector 503 may detect a change in the voice of a talker recognized by the object detector 502, as an event during a conference. As a result, the recorder 504, in a case of a change in a specific talker, can record image data or audio data at such timing when the specific talker starts talking or stops talking, for example.

It is to be noted that the recorder 504 may separately record the time information and image data in the past only by a predetermined time, and all the time information and image data in the past before the detection timing. In other words, the recorder 504 may record the image data corresponding to the time information as first data, and may record all the image data from the start time to an end time of a conference as second data. In such a case, the time information recorded in first data corresponds to a time (relative time) from the start time to the end time of the second data.

The first data and the second data may be recorded in the same storage device (the flash memory 112, for example) or may be recorded respectively in different storage devices. For example, the first data of relatively small capacity may be recorded in the flash memory 112, and the second data of a relatively large capacity may be sent to a server and recorded in the server. As a result, all the image data from the start time to the end time of the conference is able to be recorded, while the storage capacity of the flash memory 112 of the own apparatus is reduced. In such a case, the user can check all the image data from the start time to the end time of the conference, by referring to the second data recorded in the server. In addition, the user can also check all the image data before and after the timing when an event occurs, by referring to the image data in a time zone corresponding to the second data by using the time information recorded in the first data.

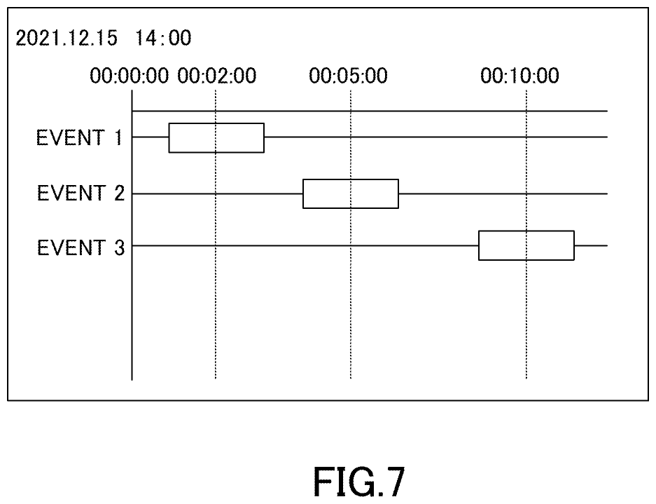

The recording method according to the present embodiment described above is also able to record conference minutes. FIG. 7 is a view showing an example in which image data is recorded as such conference minutes. As described above, the recorder 504 relates and stores time information and image data for each event. The recording apparatus (the PC 11, for example) according to the present embodiment, as shown in FIG. 7, displays the image data for each event as a time chart, on the display 117. The time chart includes the start time (the absolute time) of a conference, and the elapsed time (the relative time) from the start of the conference. The recording apparatus, for each event, relates and displays the elapsed time from the start of the conference and the image data, as a chart. In this example, the recorder 504 records image data from 1 minute before the detection timing of an event to 1 minute after the detection timing of the event. Therefore, the recording apparatus displays a chart showing that image data at the detection timing of each event and before and after the detection timing is recorded. For example, “Event 1” is detected when 2 minutes elapse from the start of the conference. Accordingly, a user learns that “Event 1” occurs when 2 minutes elapse from the start of the conference, and image data from 1 minute to 3 minutes after the start of the conference is recorded. Therefore, the user can easily check the history of the event that has occurred during the conference.

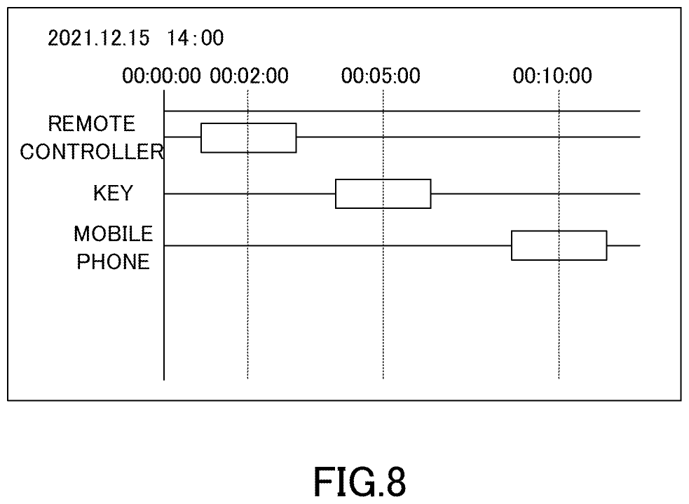

FIG. 8 is a view showing an example of conference minutes in a case in which a type of a specific object is identified. In this example, the object detector 502 identifies the type of a specific object included in the image data. For example, in the example of FIG. 8, the object detector 502 identifies a remote controller 17, a key, and a mobile phone, as the type of the specific object. The object detector 502 sets these specific objects as a target image, and outputs the information showing the type of an object, to the recorder 504. The recorder 504 relates and stores time information and image data for each type of an object. The recording apparatus (the PC 11A, for example), as shown in FIG. 8, displays the image data for each type of an object, as a time chart, on the display 117.

For example, in a case in which the event detector 503 detects as an event that an operation of the remote controller 17 is received, the recorder 504 records time information and image data at timing when the user operates the remote controller 17. The user can easily check timing when some change occurs in the remote controller 17. In addition, the user can easily check the content of a change that occurs in the remote controller 17, by checking the image data.

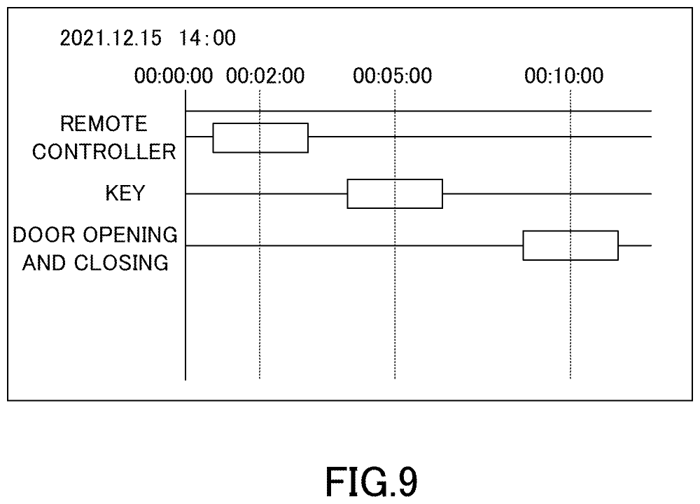

FIG. 9 is a view showing conference minutes when time information and image data are recorded, in a case in which a sound further changes. The event detector 503 detects a change in the sound obtained by the microphone 156, as an event. The recorder 504 records time information and image data when a sound changes. In addition, in this example, the event detector 503 identifies the type of a change of the sound. For example, in the example of FIG. 9, the event detector 503 identifies a door opening and closing sound. The event detector 503 outputs information showing the type of a sound to the recorder 504. The recorder 504 relates and stores time information and image data for each type of a sound. The recording apparatus (the PC 11B, for example), as shown in FIG. 9, displays the image data for each type of a sound, as a time chart, on the display 117.

As a result, the user can easily check timing when a participant of a conference enters or leaves a room. In addition, the user can easily check a person who has entered or left a room, by checking the image data.

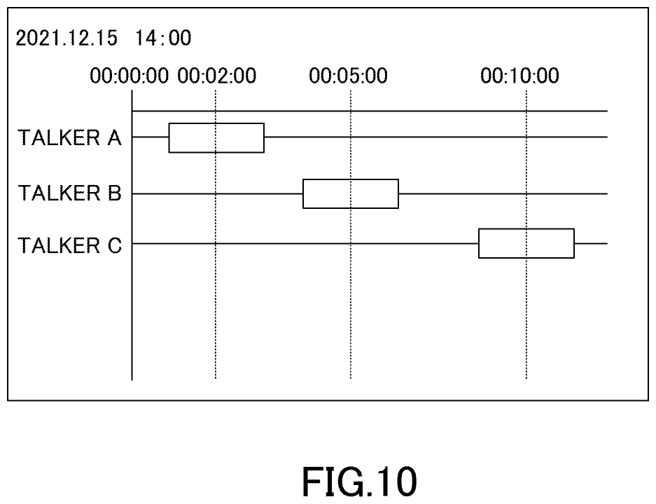

FIG. 10 is a view showing conference minutes in a case in which talker recognition is performed and time information and image data are recorded for each talker. The object detector 502 performs talker recognition processing based on the audio data. The event detector 503 detects a change in the voice of a talker recognized by the object detector 502, as an event during a conference. In addition, the event detector 503 outputs talker identification information, to the recorder 504. The talker identification information is a name of a participant, for example. The object detector 502 previously registers the name of a participant, and a voice corresponding to the name of the participant. The object detector 502 identifies the name of the participant corresponding to a recognized voice, and outputs the name as talker identification information to the recorder 504. The recorder 504 records time information and image data for each talker when the voice of a talker changes.

As a result, the user can easily check timing of a statement for each participant of a conference. In addition, the user can easily check a participant who has made a statement, by checking the image data. Furthermore, when the recorder 504 records audio data, the user can easily check the content of the statement, by checking the audio data.

The description of the foregoing embodiments is illustrative in all points and should not be construed to limit the present disclosure. The scope of the present disclosure is defined not by the foregoing embodiments but by the following claims. Further, the scope of the present disclosure includes the scopes of the claims and the scopes of equivalents.

For example, a specific object is not limited to the remote controller 17. The specific object may be a fixture in connection to a conference, such as a microphone, a speaker, or a camera, for example. In addition, the specific object may be a participant in a conference.

Although the PC 11, the PC 11A, or the PC 11B executes the recording method according to the present embodiment in the above embodiment, the terminal 15 may perform the recording method according to the present embodiment. In a case in which the terminal 15 executes the recording method according to the present embodiment, time information and image data may be recorded in a storage device (not shown) of the terminal 15 or may be recorded in the PC 11. Alternatively, the recording method according to the present embodiment may be executed by a different apparatus such as a server. The different apparatus such as a server receives image data of an image captured by the camera 154, and executes the recording method according to the present embodiment, based on received image data. In addition, the time information and the image data may be recorded in the different apparatus such as a server.

Although the above embodiment shows the conference system 1, the recording method according to the present embodiment is applicable to any system as long as the system includes a camera. For example, the recording method according to the present embodiment is applicable to a television including a camera. In such a case, the television sets a remote controller of the television as a target image. As a result, a user, when losing a remote controller of a television, can easily determine at which time the remote controller has been lost, by referring to time information, and can also easily determine how the remote controller has been lost, by referring to image data.

The recording apparatus, in a case of detecting no remote controller 17, may output an alarm tone such as “remote controller is not able to be recognized” from a speaker.

The recorder 504, although recording the detection timing of the event, time information in a past before the detection timing, and the image data, may further record time information and image data after the detection timing.

The recording method according to the present embodiment is not limited to the example of indoor use. The recording method according to the present embodiment may be used outdoors, for example, and may be used in an open space without a wall or in a semi-private room of which the wall is partially open.

The time information may include information such as a date and a day of a week. The data to be recorded may include not only time information but also position information and information (a name) of a participant. The position information may be absolute position information obtained by GPS or the like, or may be information such as a name of a used conference room. The information on the name of a conference room and a participant is able to be obtained from reservation information in a server that manages reservation of a conference room, for example.

It is to be noted that the recorded data may be made available only to administrators for the purpose of privacy protection. In addition, the recording apparatus may recognize a face of a participant from the image data, may perform processing to blur a portion of a recognized face, and may prevent the face from being viewed by users other than administrators. In addition, the recording apparatus may recognize a remote controller 17 and a user with the remote controller 17. The recording apparatus may store a remote controller 17 and a user with the remote controller 17 that are cut out of the image data.

What is claimed is:

1. A recording method comprising:
receiving image data and time information that are obtained by capturing a conference from a start time of the conference;
setting a specific object from the image data as a target image;
detecting an event during the conference; and
recording detection timing of the event, time information in a past before the detection timing, and the image data in association with the time information.

2. The recording method according to claim 1, wherein:
the specific object comprises a remote controller; and
the event comprises detection of an operation to the remote controller.

3. The recording method according to claim 1, further comprising:
receiving audio data of the conference, wherein the event comprises detection of a change in the audio data.

4. The recording method according to claim 1, wherein the event comprises detection of a change in the target image from the image data.

5. The recording method according to claim 1, further comprising:
receiving audio data of the conference;
detecting a change in the audio data; and
recording the audio data in association with recorded image data when detecting the change in the audio data.

6. The recording method according to claim 1, wherein:
the image data corresponding to the time information is recorded as first data;
the image data from the start time to an end time of the conference is recorded as second data; and
the time information corresponds to a time from the start time to the end time of the second data.

7. The recording method according to claim 1, wherein the specific object comprises a fixture related to the conference or a participant in the conference.

8. The recording method according to claim 1, further comprising:
recording the image data as conference minutes.

9. A recording apparatus comprising:
a receiver configured to receive image data and time information that are obtained by capturing a conference from a start time of the conference;
an object detector configured to set a specific object from the image data as a target image;
an event detector configured to detect an event during the conference; and
a recorder configured to record detection timing of the event, time information in a past before the detection timing, and the image data in association with the time information.

10. The recording apparatus according to claim 9, wherein:
the specific object comprises a remote controller; and
the event comprises detection of an operation to the remote controller.

11. The recording apparatus according to claim 9, wherein:
the receiver is configured to receive audio data of the conference; and
the event comprises detection of a change in the audio data.

12. The recording apparatus according to claim 9, wherein the event comprises detection of a change in the target image from the image data.

13. The recording apparatus according to claim 9, wherein:
the receiver is configured to receive audio data of the conference;
the event detector is configured to detect a change in the audio data; and
the recorder is configured to, when detecting the change in the audio data, record the audio data in association with recorded image data.

14. The recording apparatus according to claim 9, wherein:
the recorder is configured to record the image data corresponding to the time information as first data, and record the image data from the start time to an end time of the conference as second data; and
the time information corresponds to a time from the start time to the end time of the second data.

15. The recording apparatus according to claim 9, wherein the specific object comprises a fixture related to the conference or a participant in the conference.

16. The recording apparatus according to claim 9, wherein the recorder is configured to record the image data as conference minutes.
